(19) United States
(12) Patent Application Publication
(10) Pub. No.: US 2023/0232875 A1
(43) Pub. Date: Jul. 27, 2023

(54) PREPARATION METHOD OF LOW-GLYCEMIC INDEX (GI) RICE

(71) Applicant: Anhui Agricultural University, Hefei (CN)

(72) Inventors: Xianfeng Du, Hefei (CN); Yuanyuan Li, Hefei (CN); Kai Du, Hefei (CN)

(73) Assignee: Anhui Agricultural University, Hefei (CN)

(21) Appl. No.: 17/857,195

(22) Filed: Jul. 5, 2022

(30) Foreign Application Priority Data
Jan. 21, 2022 (CN) 202210072109.0

(51) Int. Cl. A23L 7/143; A23L 7/10; A23L 33/00

(52) U.S. Cl. CPC A23L 7/143; A23L 7/197; A23L 33/30

(57) ABSTRACT

A preparation method of a low-glycemic index (GI) rice includes: S1. washing indica rice grains to remove impurities, soaking the indica rice grains, and subjecting the indica rice grains to an ultrasonic treatment in excess water; S2. filtering out the indica rice grains, and cooking the indica rice grains for 20 min to 40 min; S3. subjecting indica rice grains obtained after the cooking to an ultra-high pressure treatment at 300 MPa to 600 MPa for 30 min to 35 min in a high-pressure container filled with water; S4. air-cooling indica rice grains obtained after the ultra-high pressure treatment, and refrigerating the indica rice grains; S5. after the refrigerating is completed, oven-drying the indica rice grains at 30° C. to 35° C. until a moisture content is less than 16%; and S6. shelling resulting indica rice grains to obtain the desired low-GI rice.

### CROSS REFERENCE TO THE RELATED APPLICATIONS

This application is based upon and claims priority to Chinese Patent Application No. 202210072109.0, filed on Jan. 21, 2022, the entire contents of which are incorporated herein by reference.

### TECHNICAL FIELD

The present disclosure relates to the technical field of rice processing, and in particular to a preparation method of a low-glycemic index (GI) rice.

### BACKGROUND

Rice is a staple food with a long history in China and is eaten by the largest number of people. The ways of eating rice are different by era and/or country. The history of changes from original brown rice to polished rice and then from polished rice to brown rice is also the history of changes in human cognition for nutritional functions of the staple food. When rice serves as a staple food, the problems of high starch content, high GI, and the like have always been the concern of health-conscious people, especially people with diabetes. Diet therapy is currently the main adjuvant therapy for diabetes, and its research focuses on low-GI foods. Ordinary rice and other staple foods have become contraindications for diabetics.

From the perspective of nutrition, low-GI rice has relatively-high nutritional values, because low-GI rice not only completely retains the nutrition of brown rice, but also absorbs some nutrients in rice husks during a cooking process. The dietary fiber, mineral, and vitamin contents in low-GI rice are significantly higher than that in untreated rice. At present, the low-GI foods on the market are mainly flour products such as biscuits, bread, and steamed buns, and there are relatively few low-GI staple foods safe for diabetics.

The existing technologies for GI reduction include: (1) An extract capable of inhibiting the activity of α-amylase is added to a product to achieve the purpose of GI reduction; (2) miscellaneous grains and rice are mixed, crushed, and then subjected to granulation, thereby achieving the purpose of GI reduction; (3) miscellaneous grains and rice are modified by extrusion, puffing, recombination, or the like to change the shapes and structures of the miscellaneous grains and rice; and (4) an organic acid and a microwave treatment are used in combination to reduce GI. However, the miscellaneous grains obtained after modification and granulation have problems such as poor taste and cannot be widely accepted by consumers; and the recombination or exogenous substance addition will be resisted by people who pursue natural staple foods, and the combination with low-GI miscellaneous grains can also easily lead to poor palatability and poor fusion, which cannot satisfy people's pursuit for excellent taste.

### SUMMARY

In order to solve the above-mentioned technical problems, the present disclosure provides a preparation method of a low-GI rice, where indica rice grains are used as a raw material, preparation steps are easy to operate, and a product has prominent taste and low GI.

The present disclosure adopts the following technical solutions.

A preparation method of a low-GI rice is provided, including the following steps:

S1. washing indica rice grains to remove impurities, soaking the indica rice grains in water at 20° C. to 25° C. for 9 h to 10 h, and after soaking, subjecting the indica rice grains to an ultrasonic treatment in excess water;

S2. after the ultrasonic treatment is completed, filtering out the indica rice grains, and cooking the indica rice grains in excess water for 20 min to 40 min;

S3. placing indica rice grains obtained after the cooking in a vacuum bag for sealing, and subjecting the indica rice grains in the vacuum bag to an ultra-high pressure treatment at 300 MPa to 600 MPa for 30 min to 35 min in a high-pressure container filled with water;

S4. air-cooling indica rice grains obtained after the ultra-high pressure treatment, and refrigerating the indica rice grains for 45 h to 50 h in a refrigerator at 0° C. to 4° C.;

S5. after the refrigerating is completed, oven-drying the indica rice grains in a blast air oven at 30° C. to 35° C. until a moisture content in the indica rice grains is less than 16%; and

S6. shelling indica rice grains obtained after the treatment in S5 to obtain the desired low-GI rice.

Preferably, in S1, the ultrasonic treatment may be conducted at a power of 400 W to 600 W for 30 min.

Preferably, in S1, after the soaking, the indica rice grains may be rinsed and subjected to under-full rice grain removal.

Preferably, in S3, the ultra-high pressure treatment may be conducted at 50° C. to 60° C.

The present disclosure also provides a low-GI rice prepared by the preparation method of a low-GI rice described above.

The present disclosure has the following beneficial effects.

1. The ultrasonic treatment can change an internal structure of a rice grain tissue and break cells, and the auxiliary soaking can shorten a time for rice grains to absorb water and greatly shorten a soaking time of rice grains during cooking, thereby speeding up the product preparation process. The longer the ultrasonic time, the higher the moisture content in rice grains. The rice grains absorbs enough water in a short time, such that the starch in rice grains can be fully gelatinized in the later cooking. The ultrasonic treatment will also increase a content of head rice.

2. The cooking based on ultrasonic treatment can significantly shorten the optimal cooking time for acquiring low-GI rice, reduce the influence of cooking on the texture characteristics and sensory quality of rice, and promote the release of starch in rice grains during cooking to some degree.

3. In the ultra-high pressure treatment, a volume of water in the container is larger than a volume of indica rice grains, which facilitates the rice grains to fully absorb water during the ultra-high pressure treatment and promotes the gelatinization. The ultra-high pressure treatment is conducted at a temperature controlled at 50° C. to 60° C. and a pressure controlled at 300 MPa to 400 MPa, which is favorable for the gelatinization of starch in rice grains, can shorten the cooking time and improve the appearance quality of cooked rice grains, and is an available potential technology for producing high-quality rice. In addition, the ultra-high pressure treatment greatly increases a content of resistant starch in indica rice grains, improves a nutritional value of indica rice grains, and conforms to the concept of low-GI food. Moreover, the ultra-high pressure treatment leads to a stable sterilization effect, and can retain the original flavor and nutrition of the food, improve the taste quality of the prepared low-GI rice to some degree, and promote the absorption of food nutrients by the human body.

4. The refrigeration process is an aging process of starch in rice grains, which can accelerate the aging of gelatinized starch and increase a content of slowly digestible starch (SDS) in rice grains. In addition, under the premise of ensuring the quality of rice, the refrigeration is conducive to the storage of rice.

5. According to test results, the low-GI rice obtained by the present disclosure shows little difference in elasticity and hardness from the normally-cooked rice, has a favorable taste and strong palatability, and is relatively easy to be accepted by consumers.

6. The low-GI rice obtained by the present disclosure has a GI value of less than 55 and is suitable for diabetics, which can satisfy the dependence of special populations on the staple food. According to solid-phase microextraction combined with gas chromatography-mass spectrometry (SPME/GC-MS), volatile substances in the obtained low-GI rice are not much different from those in untreated rice, indicating that the aroma of the rice obtained by the preparation method of the present disclosure does not lose too much, which ensures the nutrition and aroma components of the low-GI rice.

7. No extrusion, puffing, recombination, and the like are involved from the beginning to the end of the preparation of the present disclosure, and the preparation method is simple, has a low cost and a low broken rice rate, and leads to remarkable economic benefits. In addition, no exogenous substance is added in the preparation process, which satisfies the requirements of people who pursue natural food.

### BRIEF DESCRIPTION OF THE DRAWINGS

FIG. 1A and FIG. 1B show the appearance comparison between the low-GI rice prepared by the present disclosure and common indica rice, where FIG. 1A is for the common indica rice and FIG. 1B is for the low-GI rice;

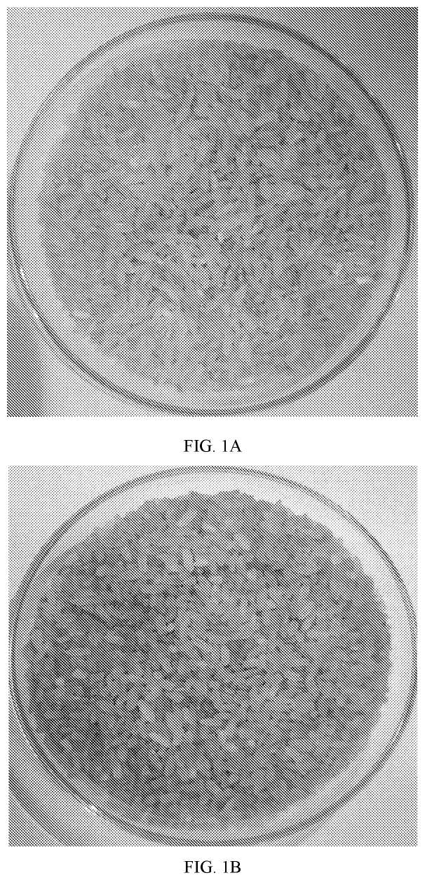

FIG. 2A and FIG. 2B show ion chromatograms of volatile components of the low-GI rice prepared by the present disclosure and common indica rice, where FIG. 2A is for the common indica rice and FIG. 2B is for the low-GI rice; and

FIG. 3 shows aroma components and relative contents thereof in the low-GI rice prepared by the present disclosure and common indica rice.

### DETAILED DESCRIPTION OF THE EMBODIMENTS

For ease of understanding, the technical solutions of the present disclosure will be described in detail below with reference to the examples and the accompanying drawings.

### Example 1

A preparation method of a low-GI rice was provided, including the following steps:

S1. Indica rice grains were washed to remove impurities, and then soaked in room-temperature water at 22° C. to 25° C. for 9 h, such that water molecules slowly penetrated into the indica rice grains; the indica rice grains were rinsed, and under-full indica rice grains were removed; and resulting indica rice grains were subjected to an ultrasonic treatment for 30 min in excess water at 500 W.

S2. After the ultrasonic treatment was completed, the indica rice grains were filtered out and cooked in excess water for 30 min.

S3. Indica rice grains obtained after the cooking were placed in a vacuum bag and sealed, then the vacuum bag was placed in a high-pressure container, and an ultra-high pressure treatment was conducted at 300 MPa and 50° C. for 30 min, where a volume of water in the high-pressure container should be larger than a volume of the indica rice grains, such that the rice grains fully absorbed water during the ultra-high pressure treatment to promote the gelatinization; and the ultra-high pressure treatment temperature and pressure (namely, to select a specific pressure, temperature, and time) were conducive to the gelatinization of starch in the rice grains.

S4. Indica rice grains obtained after the ultra-high pressure treatment were air-cooled, and then refrigerated for 45 h in a refrigerator at 0° C. to 4° C.

S5. After the refrigerating was completed, the indica rice grains were oven-dried in a blast air oven at 30° C. until a moisture content in the indica rice grains was less than 16%.

S6. Indica rice grains obtained after the treatment in S5 were shelled to obtain the desired low-GI rice.

### Example 2

A preparation method of a low-GI rice was provided, including the following steps:

S1. Indica rice grains were washed to remove impurities, and then soaked in room-temperature water at 20° C. to 25° C. for 10 h, such that water molecules slowly penetrated into the indica rice grains; the indica rice grains were rinsed, and under-full indica rice grains were removed; and resulting indica rice grains were subjected to an ultrasonic treatment for 30 min in excess water at 550 W.

S2. After the ultrasonic treatment was completed, the indica rice grains were filtered out and cooked in excess water for 38 min.

S3. Indica rice grains obtained after the cooking were placed in a vacuum bag and sealed, then the vacuum bag was placed in a high-pressure container, and an ultra-high pressure treatment was conducted at 400 MPa and 50° C. for 30 min, where a volume of water in the high-pressure container should be larger than a volume of the indica rice grains, such that the rice grains fully absorbed water during the ultra-high pressure treatment to promote the gelatinization; and the ultra-high pressure treatment temperature and pressure were conducive to the gelatinization of starch in the rice grains.

S4. Indica rice grains obtained after the ultra-high pressure treatment were air-cooled, and then refrigerated for 48 h in a refrigerator at 0° C. to 4° C.

S5. After the refrigerating was completed, the indica rice grains were oven-dried in a blast air oven at 35° C. until a moisture content in the indica rice grains was less than 16%.

S6. Indica rice grains obtained after the treatment in S5 were shelled to obtain the desired low-GI rice.

### Example 3

A preparation method of a low-GI rice was provided, including the following steps:

S1. Indica rice grains were washed to remove impurities, and then soaked in room-temperature water at 20° C. to 25° C. for 9.5 h, such that water molecules slowly penetrated into the indica rice grains; the indica rice grains were rinsed, and under-full indica rice grains were removed; and resulting indica rice grains were subjected to an ultrasonic treatment for 30 min in excess water at 600 W.

S2. After the ultrasonic treatment was completed, the indica rice grains were filtered out and cooked for 22 min.

S3. Indica rice grains obtained after the cooking were placed in a vacuum bag and sealed, then the vacuum bag was placed in a high-pressure container, and an ultra-high pressure treatment was conducted at 500 MPa and 50° C. for 30 min, where a volume of water in the high-pressure container should be larger than a volume of the indica rice grains, such that the rice grains fully absorbed water during the ultra-high pressure treatment to promote the gelatinization; and the ultra-high pressure treatment temperature and pressure were conducive to the gelatinization of starch in the rice grains.

S4. Indica rice grains obtained after the ultra-high pressure treatment were air-cooled, and then refrigerated for 48 h in a refrigerator at 0° C. to 4° C.

S5. After the refrigerating was completed, the indica rice grains were oven-dried in a blast air oven at 35° C. until a moisture content in the indica rice grains was less than 16%.

S6. Indica rice grains obtained after the treatment in S5 were shelled to obtain the desired low-GI rice.

### Example 4

The physicochemical properties of the low-GI rice prepared in each of Examples 1 to 3 were analyzed, and the common cooked indica rice was adopted as a control.

1. Determination of Water Absorption Rate

Experimental method: 20 g of cleaned rice in each of the experimental groups 1 to 3 and the control group were accurately weighed and soaked for 20 min, then the surface water was immediately removed with a paper towel, and then the rice was spread in a clean petri dish, subjected to water equilibrium in a 37° C. vacuum drying oven for 1 h, taken out and air-cooled, and weighed. A ratio of a rice weight difference before and after water absorption to the original rice weight was the water absorption rate.

Rice water absorption rate (%)=(weight after water absorption−weight before water absorption)/weight before water absorption×100%

Results are shown in Table 1, and it can be seen from the table that a water absorption rate of the low-GI rice prepared by the present disclosure is slightly higher than that of the common rice.

TABLE 1
Water absorption rate of low-GI rice

| Group | Water absorption rate/% |
|---|---|
| Example 1 | 20.32 |
| Example 2 | 22.21 |
| Example 3 | 21.19 |
| Control | 20.29 |

2. Determination of Viscosity and Elasticity

The texture characteristics of the cooked rice were determined using a TA-XT2i texture analyzer (SMS, UK). The rice cooking was conducted in accordance with the national standard GB/T15682-2008. 20 g of rice was taken and washed three times, then washed rice was mixed with water in a rice-to-water ratio of 1:1.3, and a resulting mixture was placed in an aluminum box (90 mm in diameter and 50 mm in height) and then cooked in a steamer. 10 rice grains were randomly selected from different positions of the aluminum box and placed symmetrically on an object stage of the texture analyzer for test, where there was a specified interval among the rice grains and 5 parallel tests were conducted for each sample.

Test results are shown in Table 2, and it can be seen that the elasticity and hardness of the low-GI rice prepared by the present disclosure are not much different from those of the rice obtained after normal cooking.

TABLE 2
Elasticity and hardness of low-GI rice

| Group | Elasticity value/mm | Hardness value/g |
|---|---|---|
| Example 1 | 0.41 | 2310 |
| Example 2 | 0.43 | 2423 |
| Example 3 | 0.49 | 2532 |
| Control | 0.42 | 3531 |

3. Determination of GI Value

Each of the low-GI rice and untreated indica rice was thoroughly crushed and sieved through a 100-mesh sieve to obtain a rice flour. With 200 mg of white bread crushed in the same way as a reference, 200 mg of the rice flour was accurately weighed and added to a 50 mL centrifuge tube, and then 20 mL of phosphate buffered saline (PBS, 0.12 mol/L NaCl, 2.7 mmol/L KCl, and 0.01 mol/L phosphate) was added; a pH was adjusted to 1.5 with 1 mol/L HCl, and a resulting mixture was thoroughly shaken; 0.2 mL of a pepsin solution (115 μ/mL) was added, a resulting mixture was incubated in a water bath at 37° C. for 30 min, and then the sample was taken out and cooled to room temperature; a pH was adjusted to 6.86 with 1 mol/L NaOH, then 1 mL of a α-amylase solution (110 μ/mL) was added, and a volume was increased to 50 mL with PBS (pH=6.9); a resulting solution was shaken in a constant-temperature water bath at 37° C. for 1 h, and then 500 μL of a sample was collected every 30 min during a period of 0 to 3 h after the shaking (6 times in total); 1.5 mL of a 0.4 mol/L a sodium acetate buffer (pH 4.75) was added per mL of a sample solution, then 30 μL of glucoamylase (110 μ/mL) was added, and a resulting mixture was shaken in a constant-temperature water bath at 50° C. for 30 min; a content was then diluted to 10 mL with distilled water, 1 μL of a resulting sample was taken and mixed with 1 mL of a glucose oxidase/peroxidase (GOPOD) reagent, and a resulting mixture was then incubated at 37° C. for 15 min; and the absorbance was determined at 510 nm. In this section, the kit was used instead of the mean value for plotting a curve, and then an area under the curve (AUC) was calculated with glucose (0.2 g) as a standard carbohydrate. A predicted GI of a test sample prepared by each preparation method was calculated by dividing an AUC of the test sample with an AUC of glucose in white bread.

Results are shown in Table 2, and it can be seen that a GI value of the indica rice prepared by the present disclosure is significantly lower than that of the ordinary indica rice in the control group.

TABLE 2
Determination results of GI value of low-GI rice

| Group | GI value |
|---|---|
| Example 1 | 51 |
| Example 2 | 48 |
| Example 3 | 46 |
| Control | 76 |

4. Determination of Aroma Components

Sample preparation: The two kinds of rice were each crushed, sieved through a 100-mesh sieve, and placed in a dry and sealed pot for later use. A 10 mL headspace vial was prepared, 3 g of a sample was added, and then the headspace vial was capped and sealed for later use.

SPME conditions: The headspace vial filled with the sample was equilibrated in a constant-temperature water bath at 80° C. for 1 h, then an extraction fiber was inserted into the headspace vial to allow extraction for 50 min, and analysis was conducted at an injection port of GC-MS for 5 min.

GC conditions: The HP-5MS capillary column was used as a capillary column, and a carrier gas flow rate was 1 mL/min. Temperature programming: An initial temperature of the column was 50° C., and then the temperature was continuously raised to 125° C. at 8° C./min and held for 3 min, then raised to 165° C. at 4° C./min and held for 3 min, and finally raised to 250° C. at 10° C./min and held for 2 min; and a non-splitting mode was adopted.

MS conditions: interface temperature: 280° C.; ion source: electron ionization (EI); ion source temperature: 230° C.; electron energy: 70 eV; scanning range (m/z): 35 amu to 500 amu; and full-scan acquisition mode.

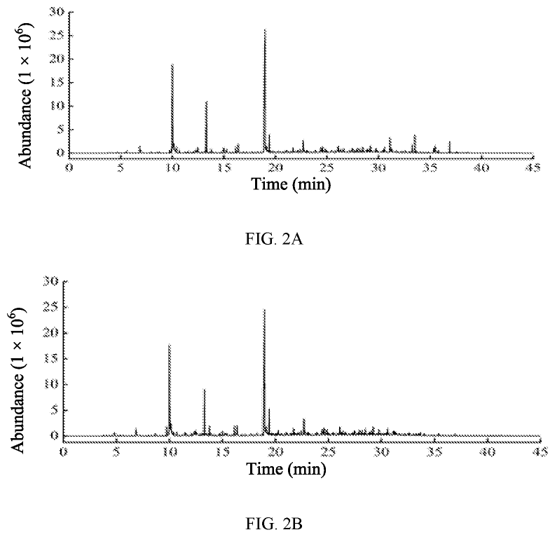

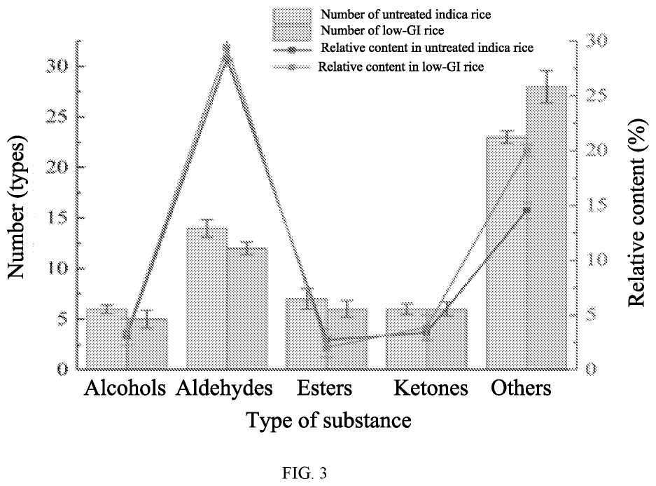

The aroma components in rice were qualitatively detected. A total of 57 volatile components were detected in the low-GI rice, and a total of 56 volatile components were detected in the common indica rice in the control group, as shown in FIG. 2A, FIG. 2B, FIG. 3, and Table 3, indicating that the preparation method does not result in much aroma loss of the rice and ensures the nutrition and aroma components of the low-GI rice.

TABLE 3
Relative volatile component contents and aroma
characteristics of low-GI rice

| | | | | Relative content/% | |
|---|---|---|---|---|---|
| | | Retention | | Low-GI | |
| Type | No. | time/min | Compound name | rice | Control |
| | 1 | 10.149 | 1-Octen-3-ol | 1.21 | 0.71 |
| | 2 | 19.722 | 2-Hexyl-1-decanol | 0.30 | — |
| | 3 | 22.425 | Myristyl alcohol | 0.58 | 0.42 |
| Alcohols | 4 | 26.086 | 1-Pentadecanol | 1.27 | 1.05 |
| | 5 | 29.046 | 1-Hexadecanol | 0.11 | 0.46 |
| | 6 | 7.982 | n-Hexanol | — | 0.15 |
| | 7 | 23.051 | l-Heptadecanol | — | 0.36 |
| | 1 | 6.836 | Hexanal | 1.12 | 1.05 |
| | 2 | 8.633 | Heptanal | 0.19 | 0.17 |
| | 3 | 9.737 | Cis-2-heptenal | 1.33 | 0.41 |
| | 4 | 10.009 | Benzaldehyde | 15.61 | 14.89 |
| | 5 | 10.686 | Octanal | 0.50 | 0.38 |
| | 6 | 12.066 | Trans-2-octenal | 0.37 | 0.28 |
| | 7 | 13.315 | Nonanal | 7.15 | 8.16 |
| Aldehydes | 8 | 15.271 | Phenylpropanal | 0.48 | 0.59 |
| | 9 | 15.249 | Decanal | 1.53 | 1.31 |
| | 10 | 17.19 | Trans-cinnamaldehyde | 0.36 | 0.35 |
| | 11 | 18.253 | Trans-2-decenal | 0.48 | — |
| | 12 | 21.828 | 2-Butyl-2-octenal | 0.28 | — |
| | 13 | 11.887 | Phenylacetaldehyde | — | 0.15 |
| | 14 | 16.852 | (E,E)-2,4-nonadienal | — | 0.25 |
| | 15 | 18.801 | 4-tert-Butylbenzaldehyde | — | 0.22 |
| | 16 | 19.711 | Undecanal | — | 0.21 |
| | 1 | 10.254 | Methylheptenone | 0.29 | 0.25 |
| | 2 | 11.513 | 3-Octen-2-one | 0.48 | 0.33 |
| Ketones | 3 | 12.351 | 3,5-Octadien-2-one | 0.79 | 0.30 |
| | 4 | 12.473 | Acetophenone | 1.06 | 1.21 |
| | 5 | 33.688 | Phytone | 0.28 | 0.15 |
| | 6 | 24.412 | Geranyl acetone | 0.98 | 0.82 |
| | 7 | 5.591 | Acetoin | — | 0.35 |
| | 1 | 15.422 | Vinyl benzoate | 0.51 | — |
| | 2 | 25.444 | Ethyl cinnamate | 0.64 | 0.57 |
| | 3 | 27.224 | Butyl tetradecanoate | 0.27 | |
| | 4 | 33.263 | Octyl salicylate | 0.25 | 0.89 |
| Esters | 5 | 34.01 | Diisobutyl phthalate | 0.19 | — |
| | 6 | 35.376 | Dibutyl phthalate | 0.23 | — |
| | 7 | 4.569 | Vinyl acetate | — | 0.30 |
| | 8 | 12.286 | Octyl formate | — | 0.56 |
| | 9 | 15.426 | Methyl benzoylformate | — | 0.23 |
| | 10 | 35.781 | Ethyl palmitate | — | 0.19 |
| | 1 | 4.836 | Trichloromethane | 0.83 | — |
| | 2 | 5.353 | Triethylamine | 0.15 | — |
| | 3 | 8.17 | m-Xylene | 0.09 | — |
| | 4 | 8.598 | Styrene | 0.33 | — |
| Others | 5 | 10.419 | 2-pentylfuran | 0.44 | — |
| | 6 | 11.463 | D-terpadiene | 0.12 | — |
| | 7 | 13.114 | Undecane | 0.25 | — |
| | 8 | 16.143 | Dodecane | 0.25 | 0.86 |
| | 9 | 14.72 | 5-Methylundecane | 0.30 | — |
| | 10 | 14.856 | 4-Methylundecane | 0.17 | — |
| | 11 | 15.224 | 3-Methylundecane | 0.34 | — |
| | 12 | 27.944 | 3 -Methylpentadecane | — | 0.64 |
| | 13 | 29.931 | Cedrol | — | 0.16 |
| | 14 | 16.145 | Dodecane | 1.38 | |
| | 15 | 19.134 | 1-Tridecene | 0.65 | 0.43 |
| | 16 | 19.408 | n-Tridecane | 4.00 | 2.68 |
| | 17 | 19.881 | 2-Methylnaphthalene | — | 0.10 |
| | 18 | 22.776 | 5,5-Dibutylnonane | — | 0.57 |
| | 19 | 20.287 | Heptamethylnonane | 0.65 | — |
| | 20 | 21.076 | Cyclohexylheptane | 0.37 | — |
| | 21 | 24.977 | 4-Methyltetradecane | 0.99 | 1.09 |
| | 22 | 22.691 | Tetradecane | 2.64 | 1.93 |
| | 23 | 22.779 | 3-Methyltetradecane | 0.80 | — |
| | 24 | 35.378 | Palmitic acid | — | 0.75 |
| Others | 25 | 23.053 | 1-Heptadecene | 0.42 | — |
| | 26 | 33 607 | 5,9,13-Trimethyl-4,8,12- | — | 0 10 |
| | | | tetradecatrienyl | | |
| | 27 | 23.179 | 1-Nonadecene | 0.31 | 0.27 |
| | 28 | 23.053 | 10-Methyleicosane | 0.39 | — |
| | 29 | 26.353 | Pentadecane | 0.65 | 0.56 |
| | 30 | 33.09 | 5,5-Diethylpentadecane | — | 0.13 |
| | 31 | 28.167 | Nonylcyclohexane | 0.60 | 0.52 |
| | 32 | 32.571 | Undecylcyclohexane | — | 0.15 |
| | 33 | 28.487 | 3-Methylpentadecane | 0.78 | 0.51 |
| | 34 | 29.233 | Hexadecane | 1.05 | 0.90 |
| | 35 | 30.579 | Cyclohexadecane | — | 0.60 |
| | 36 | 31.303 | 2,2′,5,5′- | — | 0.36 |
| | | | Tetramethylbiphenyl | | |
| | 37 | 30.581 | Undecanylcyclopentane | 0.73 | — |
| | 38 | 31.303 | 2,2′,5,5′- | 0.33 | — |
| | | | Tetramethylbiphenyl | | |
| | 39 | 3.794 | Ammonium carbamate | — | 0.18 |
| | 40 | 10.417 | 2-Pentylfuran | — | 0.76 |
| | 41 | 16.301 | Naphthalene | — | 0.28 |

Note: “—” means that it is not detected.

### Example 5

Sensory Evaluation

1. Preparation Before the Evaluation:

1) Evaluator introduction: 5 men and 5 women with tasting experience that were at an age of 23 to 30 and in good health and had no bad habits were selected.

2) Conditions: The mouth of each evaluator was rinsed with warm boiled water before each evaluation to remove residues in the mouth.

2. Evaluation Content:

1) Identification of a cooked rice smell: The cooked rice was placed under the nose of an evaluator while hot, and then the evaluator inhaled appropriately and carefully identified a smell of the cooked rice.

2) Observation of cooked rice appearance: The color, gloss, and rice grain integrity of cooked rice were observed.

3) Identification of palatability of cooked rice: A little amount of cooked rice was put in the mouth with chopsticks and chewed carefully for 3 s to 5 s, during which an evaluator carefully evaluated the viscosity, hardness, elasticity, moisture, and the like of cooked rice with sensory organs such as teeth and tongue while chewing.

4) Texture of cooled cooked rice: The cooked rice was placed at room temperature for 1 h, and then the viscoelasticity, agglomeration, and hardness of the cooled cooked rice were determined.

3. Scoring

Comprehensive scoring was conducted according to the smell, appearance structure, palatability, and taste of cooked rice and the texture of cooled cooked rice, and an average value was calculated according to the comprehensive scoring results of each evaluator. Scores of some evaluators with large errors (10 points higher than the average value) could be discarded, and then an average value was recalculated. Finally, an average value of comprehensive scores was used as a result of sensory evaluation of the edible quality of rice, and a calculation result was rounded to an integer.

The scoring rules were as follows:

TABLE 3
Sensory evaluation scoring rules for rice

| First-level | Second-level | |
|---|---|---|
| index value | index value | Specific description; score |
| Smell: 15 | Smell: 15 | Strong and long-lasting rice aroma: 15 to 12 |
| | | Rice aroma that is weak and inapparent and |
| | | easily disappears: 11 to 8 |
| | | No rice aroma: 7 to 5 |
| | | Unpleasant smell: 4 to 0 |
| Appearance: 15 | Color and | Moderate color, prominent gloss, and easy |
| | smell: 15 | dispersion: 15 to 10 |
| | | Dark color and poor gloss: 9 to 5 |
| | | Unsightly color and no gloss: 4 to 0 |
| Palatability: 30 | Hardness: 10 | Moderate hardness and prominent taste: |
| | | 10 to 8 |
| | | Slightly hard or slightly soft: 7 to 5 |
| | | Too hard and too soft: 4 to 0 |
| | Elasticity: 10 | Highly elastic: 10 to 8 |
| | | Generally elastic: 7 to 5 |
| | | Inelastic: 4 to 0 |
| | Viscosity | Viscous and agglomerated: 10 to 8 |
| | | Viscous and loose: 7 to 5 |
| | | Non-viscous and loose: 4 to 0 |

The results are shown in Table 4, and it can be seen that the taste of the treated low-GI rice can generally meet the requirements of the public.

TABLE 4
Sensory evaluation scores for rice

| Name | Sensory evaluation | Score |
|---|---|---|
| Example 1 | Moderate hardness, rich aroma, and prominent taste | 85 |
| Example 2 | Moderate hardness, and rich and layered taste | 82 |
| Example 3 | Moderate hardness, easy dispersion, and prominent taste | 81 |
| Control | Moderate hardness, excellent elasticity, and | 82 |
| | prominent taste | |

The above implementations are merely used to illustrate the technical solutions of the present disclosure, but not to limit the present disclosure. Although the present disclosure is described in detail with reference to the above implementations, those of ordinary skill in the art should understand that any modification, equivalent substitution, and improvement made within the spirit and principle of the present disclosure shall be included in the protection scope of the present disclosure.

What is claimed is:

1. A preparation method of a low-glycemic index (GI) rice, comprising the following steps:
S1) washing indica rice grains to remove impurities, soaking the indica rice grains in water at 20° C. to 25° C. for 9 h to 10 h, and after the soaking, subjecting the indica rice grains to an ultrasonic treatment in excess water;
S2) after the ultrasonic treatment is completed, filtering out the indica rice grains, and cooking the indica rice grains in excess water for 20 min to 40 min to obtain cooked indica rice grains;
S3) placing the cooked indica rice grains in a vacuum bag for a sealing, and subjecting the cooked indica rice grains in the vacuum bag to an ultra-high pressure treatment at 300 MPa to 600 MPa for 30 min to 35 min in a high-pressure container filled with water to obtained treated indica rice grains;
S4) air-cooling the treated indica rice grains, and refrigerating the treated indica rice grains for 45 h to 50 h in a refrigerator at 0° C. to 4° C. to obtained refrigerated indica rice grains;
S5) after the refrigerating is completed, oven-drying the refrigerated indica rice grains in a blast air oven at 30° C. to 35° C. until a moisture content in the refrigerated indica rice grains is less than 16% to obtain dried indica rice grains; and
S6) shelling the dried indica rice grains to obtain the low-GI rice.

2. The preparation method according to claim 1, wherein in S1, the ultrasonic treatment is conducted at a power of 400 W to 600 W for 30 min.

3. The preparation method according to claim 1, wherein in S1, after the soaking, the indica rice grains are rinsed and subjected to an under-full rice grain removal.

4. The preparation method according to claim 1, wherein in S3, the ultra-high pressure treatment is conducted at 50° C. to 60° C.

5. A low-GI rice prepared by the preparation method according to claim 1.

6. The low-GI rice according to claim 5, wherein in S1, the ultrasonic treatment is conducted at a power of 400 W to 600 W for 30 min.

7. The low-GI rice according to claim 5, wherein in S1, after the soaking, the indica rice grains are rinsed and subjected to an under-full rice grain removal.

8. The low-GI rice according to claim 5, wherein in S3, the ultra-high pressure treatment is conducted at 50° C. to 60° C.
